(19) United States
(12) Patent Application Publication
(10) Pub. No.: US 2007/0222182 A1
(43) Pub. Date: Sep. 27, 2007

(54) Tow Hitch

(76) Inventor: Roger L. Brantley, Keithville, LA (US)

Correspondence Address: SIEBERTH & PATTY, LLC, 4703 BLUEBONNET BLVD, BATON ROUGE, LA, 70809, US

(21) Appl. No.: 11/684,102

(22) Filed: Mar. 9, 2007

Related U.S. Application Data
(60) Provisional application No. 60/780,917, filed on Mar. 10, 2006.

(51) Int. Cl. B60D 1/14

(52) U.S. Cl. 280/472

(57) ABSTRACT

Apparatus having at least the following components:
a) a longitudinal member having a respective longitudinal axis, the longitudinal member being sized and configured for detachable attachment to an item of heavy equipment; and
b) a contoured member having a respective longitudinal axis and at least a first region and a second region which are not coplanar, and which first and second regions are in contact and together define an angle from the horizontal, the first region being sized and configured for detachable attachment to a trailer hitch or tow hitch;
   the longitudinal member and the contoured member being attached to each other such that the respective longitudinal axes of the members are substantially perpendicular to each other. Also provided are a kit comprising the apparatus, and a method for retrieving an item of heavy equipment.

### REFERENCE TO RELATED APPLICATION

This Application claims the benefit of prior co-pending provisional patent application No. 60/780,917, filed Mar. 10, 2006, the disclosure of which is incorporated herein by reference.

### TECHNICAL FIELD

This invention relates to hitches for towing heavy objects.

### BACKGROUND

Heavy equipment, particularly construction equipment, occasionally becomes mired or otherwise stuck in soft earth (e.g., mud). Normally, to retrieve such equipment, the piece of equipment is attached or otherwise hitched to a bulldozer or tractor, and the equipment is pulled out of the earth with the bulldozer or tractor. While this can be an effective retrieval method, an easier method would be desirable.

### SUMMARY OF THE INVENTION

This invention provides an apparatus that enables a simple and effective method for towing heavy equipment, particularly for retrieving heavy equipment from soft earth. Advantageously, the apparatus of this invention can be used with conventional trailer and tow hitches mounted on vehicles, and satisfies the need for a hitch which connects a bulldozer or other heavy-duty machinery to heavy equipment which is mired in soft earth.

One embodiment of this invention is an apparatus. The apparatus comprises a longitudinal member and a contoured member. The longitudinal member has a respective longitudinal axis, and is sized and configured for detachable attachment to an item of heavy equipment. The contoured member has a respective longitudinal axis and at least a first region and a second region which are not coplanar, and which first and second regions are in contact and together define an angle from the horizontal. The first region of the contoured member is sized and configured for detachable attachment to a trailer hitch or tow hitch. The longitudinal member and the contoured member are attached to each other such that the respective longitudinal axes of the members are substantially perpendicular to each other.

Another embodiment of this invention is a method for retrieving an item of heavy equipment. The method comprises attaching an apparatus of the above embodiment to the item of heavy equipment and to a trailer hitch or tow hitch, and towing the item of heavy equipment. The longitudinal member of the apparatus is attached to the item of heavy equipment, and the first region of the contoured member of the apparatus is attached to the trailer hitch or tow hitch.

These and other features of this invention will be still further apparent from the ensuing description, drawings, and appended claims.

### BRIEF DESCRIPTION OF THE DRAWINGS

FIG. 1 is a view of a preferred apparatus of this invention.

FIG. 2 shows views of a preferred longitudinal member of the apparatus of this invention.

FIG. 3 shows views of a preferred contoured member of the apparatus of this invention.

FIG. 4 is a view of a preferred apparatus of this invention.

FIG. 5 is a view of a preferred apparatus of this invention attached to a trailer hitch and to a backhoe.

### FURTHER DETAILED DESCRIPTION OF THE INVENTION

In this document, the term “soft earth” means an area of wet soil (e.g., mud), sand, or the like that is soft enough to allow the item of heavy equipment to subside into such soft earth to an extent that the item of heavy equipment cannot traverse the area under its own power.

As stated above, the apparatus of this invention comprises a longitudinal member and a contoured member; the longitudinal member having a respective longitudinal axis, and being sized and configured for detachable attachment to an item of heavy equipment. Preferably, the longitudinal member is rectangular in cross-section through the respective longitudinal axis of the longitudinal member. The longitudinal member can be solid, partially hollow, or hollow. When hollow or partially hollow, the longitudinal member can be enclosed or unenclosed (open at the ends of the longitudinal axis or closed at the ends of the longitudinal axis). Preferably, the longitudinal member is hollow and also is preferably unenclosed.

The contoured member has a respective longitudinal axis and at least a first and a second region which are not coplanar, the first and second regions being in contact and together defining an angle from the horizontal. The first region is sized and configured for detachable attachment to a trailer hitch or tow hitch. The angle defined by the first and second regions is typically in the range of about 90 degrees to about 150 degrees from the horizontal, and preferably the angle is in the range of about 90 degrees to about 130 degrees from the horizontal. The angle formed by the first and second regions is more preferably about 90 degrees or about 120 degrees from the horizontal. The angle is measured with the first region horizontal.

In some embodiments of the invention, the contoured region of the apparatus further comprises a third region, which third region adjoins the second region. The third region is not coplanar with the second region. Normally and preferably, the third region is in contact with the longitudinal member.

The longitudinal axis of the longitudinal member is substantially perpendicular to the longitudinal axis of the contoured member. While the contoured member may be positioned anywhere along the longitudinal axis of the longitudinal member, the contoured member is preferably proximate to one end of the longitudinal member. Another preferred feature of the apparatus of the invention is a wedge attached to the longitudinal member and to the second region of the contoured member.

In the apparatus of the invention, the longitudinal member and the contoured member are attached to each other by means strong enough to withstand the forces that the apparatus experiences when it is used to tow heavy equipment. Thus, the apparatus of the invention is normally and preferably made of steel, and the longitudinal member and the contoured member are preferably welded together, or are formed as a single unitary piece. When a wedge is present, it is preferably welded to both the longitudinal member and the contoured member; alternatively, the wedge may be part of a single unitary piece that is the apparatus of the invention.

It is to be understood that the apparatus of this invention can be manufactured in different sizes, as the appropriate size will vary with the item of heavy equipment to be towed.

Examples of the types of heavy equipment that can be retrieved from soft earth in which it is stuck include, but are not limited to, backhoes, bulldozers, excavators, and the like. Examples of the types of heavy equipment that can be used to tow heavy equipment that is stuck in soft earth include, but are not limited to, backhoes, bulldozers, excavators, and the like.

As described above, the apparatus of the invention is attached to an accessory mount of an item of heavy equipment via the longitudinal member, and apparatus of the invention is attached to a trailer hitch or tow hitch via the first region of the contoured member.

Generally, vehicles or items of heavy equipment with the ability to pull heavy loads are used in the practice of this invention. The vehicles or items of heavy equipment include pickup trucks, backhoes, bulldozers, excavators, and the like. In other words, in at least some situations, both the object being towed (and to which the longitudinal member is attached) and the object doing the towing (and to which the first region of the contoured member is attached) are items of heavy equipment. The tow hitch or trailer hitch to which the apparatus of the invention is attached can be located on the vehicle or item of heavy equipment itself, or on a trailer to which the vehicle or item of heavy equipment is attached.

The method of the invention for retrieving an item of heavy equipment comprises attaching an apparatus of the invention to the item of heavy equipment and a trailer hitch or tow hitch, and towing the item of heavy equipment. Attachment is accomplished by attaching the longitudinal member of the apparatus to the item of heavy equipment and attaching the contoured member of the apparatus to the trailer hitch or tow hitch.

A kit of this invention comprises an apparatus of this invention, and a first attachment means for detachably attaching the longitudinal member to an item of heavy equipment and a second attachment means for detachably attaching the contoured member to a trailer hitch or tow hitch. Suitable attachment means include, but are not limited to, clamps, screws, bolts, cotter pins, and the like. Preferred attachment means include bolts and screws. To accommodate the attachment means, the longitudinal member and the first region of the contoured member of the apparatus are sized and figured appropriately, e.g., when the attachment means is a screw, the longitudinal member or first region defines a threaded hole; when the attachment means is a bolt, the longitudinal member or first region defines an unthreaded hole.

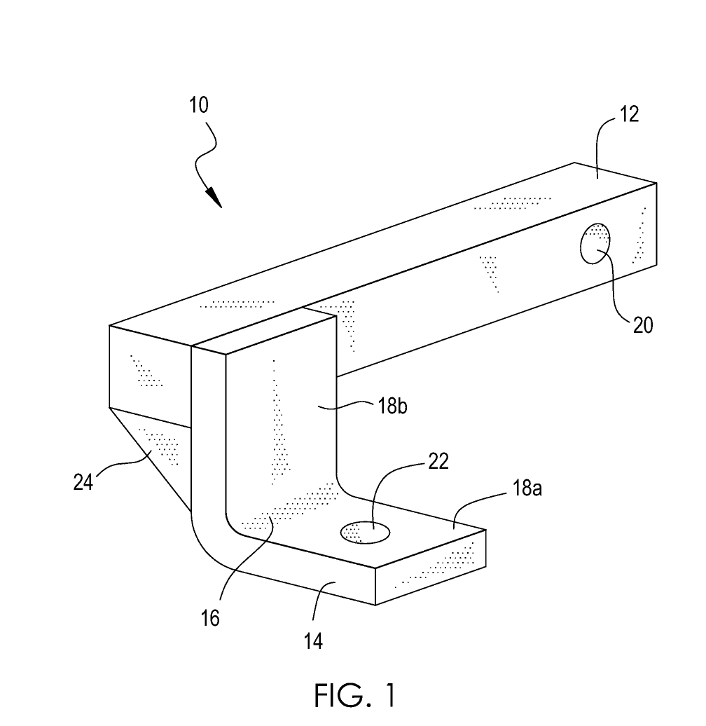

Referring now to the Figures, FIG. 1 is a view of a preferred apparatus 10 of this invention, showing longitudinal member 12 and contoured member 14. Angle 16 of the contoured member is defined by the first and second regions 18a and 18b, respectively, which are in contact and are not coplanar. On longitudinal member 12, there is a preferred attachment means 20, and on first region 18a, there is a preferred attachment means 22. Second region 18b is in contact with longitudinal member 12. There is also a wedge 24, which is attached to the longitudinal member 12 and to the contoured member 14.

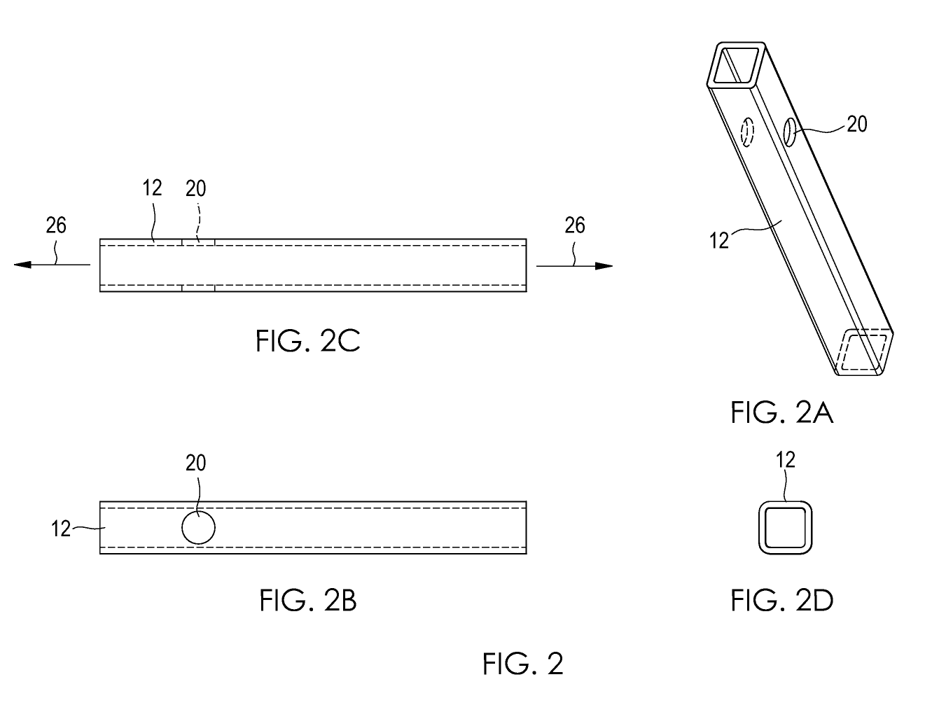

FIG. 2 shows views of a preferred configuration of a longitudinal member 12 of the apparatus of this invention. FIG. 2A is a perspective view of a hollow longitudinal member 12 having attachment means 20. FIG. 2B is a front view of the longitudinal member 12, showing the attachment means 20. FIG. 2C is a top plan view of the longitudinal member 12, showing the respective longitudinal axis 26 of the longitudinal member 12. FIG. 2D is a side view of the longitudinal member 12.

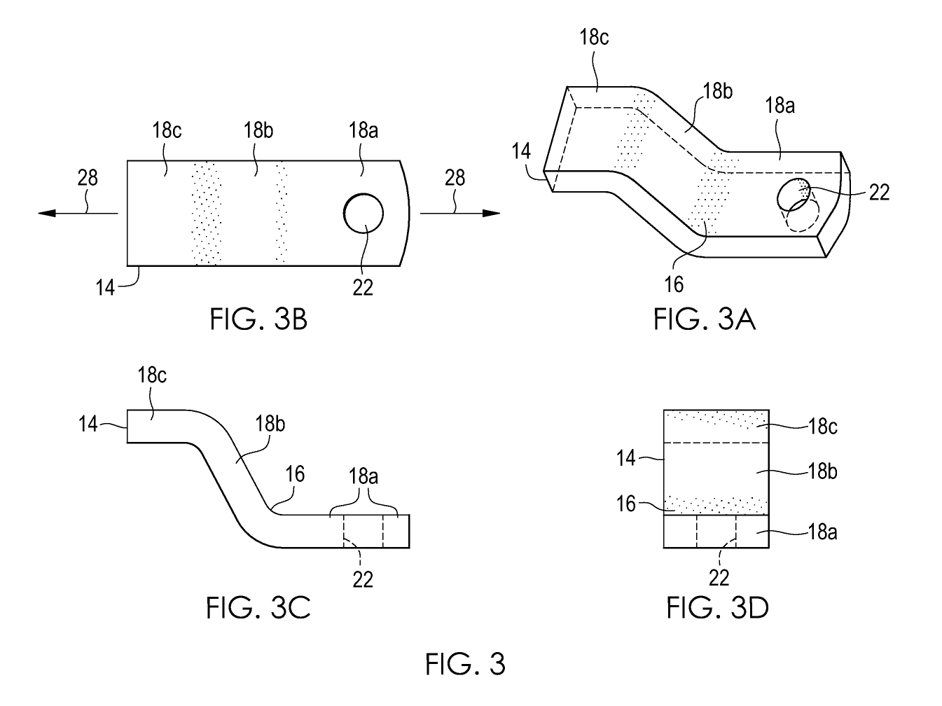

FIG. 3 shows views of a preferred configuration of a contoured member 14 of the apparatus of this invention. FIG. 3A is a perspective view of the contoured member 14, showing angle 16, defined by first region 18a and second region 18b, which are in contact and are not coplanar. A third region 18c which is not coplanar with the adjoining second region 18b is part of the contoured member 14. A preferred attachment means 22 is in first region 18a. FIG. 3B is a top plan view of the contoured member 14, with first region 18a and second region 18b which are not coplanar, and third region 18c which is not coplanar with the adjoining second region 18b. Also shown is the respective longitudinal axis 28 of the contoured member 14. FIG. 3C is a left elevational view of contoured member 14 having angle 16, defined by first and second regions 18a and 18b, which are in contact and are not coplanar. A third region 18c which is not coplanar with the adjoining second region 18b is part of contoured member 14. FIG. 3D is a front view of the contoured member 14 showing first and second regions 18a and 18b, and third region 18c. When contoured member 14 as shown in FIGS. 3A-3D is part of an apparatus of the invention, preferably both second region 18b and third region 18c are in contact with the longitudinal member.

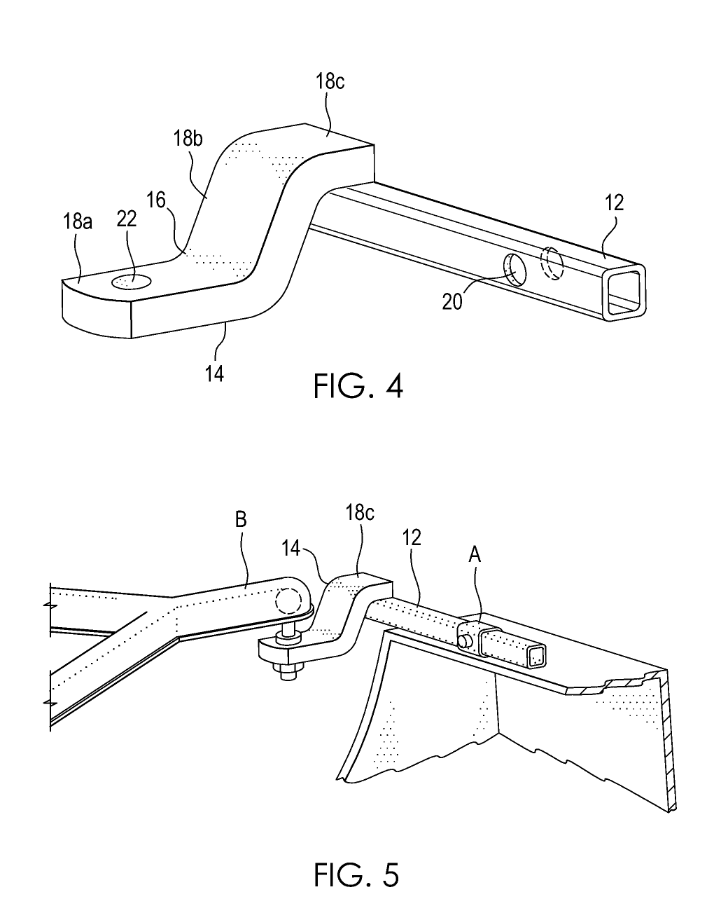

FIG. 4 is a view of a preferred apparatus of this invention 10, showing longitudinal member 12 and contoured member 14. Angle 16 of the contoured member is defined by the first and second regions 18a and 18b, respectively, which are in contact and are not coplanar. On longitudinal member 12, there is a preferred attachment means 20, and in first region 18a, there is a preferred attachment means 22. Second region 18b and third region 18c are in contact with longitudinal member 12.

FIG. 5 is a view of a preferred apparatus of this invention 10 attached to a trailer hitch and to the front scoop of a backhoe. The longitudinal member 12 is attached to the accessory mount A of the backhoe via an attachment means 20. Contoured member 14 is attached to a trailer hitch B via attachment means 22. Third region 18c is in contact with longitudinal member 12.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent, patent application and printed publication referred to above is incorporated herein by reference in toto to the fullest extent permitted as a matter of law.

This invention is susceptible to considerable variation in its practice. Therefore, the foregoing description is not intended to limit, and should not be construed as limiting, the invention to the particular exemplifications presented hereinabove.

1. An apparatus which comprises
a) a longitudinal member having a respective longitudinal axis, the longitudinal member being sized and configured for detachable attachment to an item of heavy equipment; and
b) a contoured member having a respective longitudinal axis and at least a first region and a second region which are not coplanar, and which first and second regions are in contact and together define an angle from the horizontal, the first region being sized and configured for detachable attachment to a trailer hitch or tow hitch;
the longitudinal member and the contoured member being attached to each other such that the respective longitudinal axes of the members are substantially perpendicular to each other.

2. Apparatus as in claim 1 wherein the longitudinal member has at least one of the following features:
(a) it is sized and configured for attachment to an item of heavy equipment via an accessory mount hitch of the item of heavy equipment;
(b) it is rectangular in cross-section through the respective longitudinal axis of the longitudinal member.

3. Apparatus as in claim 1 wherein the contoured member has at least one of the following features:
(a) the first and second regions form an angle of about 90 degrees to about 150 degrees;
(b) the contoured member further comprises a third region which is adjoined to and not coplanar with the second region.

4. Apparatus as in claim 3 wherein the first and second regions form an angle of about 90 degrees to about 130 degrees.

5. Apparatus as in claim 3 wherein the first and second regions form an angle of about 90 degrees or about 120 degrees.

6. Apparatus as in claim 1 wherein the apparatus further comprises a wedge attached to the longitudinal member and to the second region of the contoured member.

7. A method for retrieving an item of heavy equipment, which method comprises
i) attaching an apparatus of claim 1 to an item of heavy equipment and to a trailer hitch or tow hitch, by attaching the longitudinal member of the apparatus to the item of heavy equipment and attaching the first region of the contoured member of the apparatus to the trailer hitch or tow hitch; and
ii) towing the item of heavy equipment.

8. A method as in claim 7 wherein the longitudinal member has at least one of the following features:
(a) it is sized and configured for attachment to an item of heavy equipment via an accessory mount hitch of the item of heavy equipment;
(b) it is rectangular in cross-section through the respective longitudinal axis of the longitudinal member.

9. A method as in claim 7 wherein the contoured member has at least one of the following features:
(a) the first and second regions form an angle of about 90 degrees to about 150 degrees;
(b) the contoured member further comprises a third region which is adjoined to and not coplanar with the second region.

10. A method as in claim 9 wherein the first and second regions form an angle of about 90 degrees to about 130 degrees.

11. A method as in claim 9 wherein the first and second regions form an angle of about 90 degrees or about 120 degrees.

12. A method as in claim 7 wherein the apparatus further comprises a wedge attached to the longitudinal member and to the second region of the contoured member.

13. A kit which comprises
A) an apparatus of claim 1; and
B) first attachment means for detachably attaching the longitudinal member to an item of heavy equipment and second attachment means for detachably attaching the contoured member to a trailer hitch or tow hitch.

14. A kit as in claim 13 wherein the longitudinal member has at least one of the following features:
(a) it is sized and configured for attachment to an item of heavy equipment via an accessory mount hitch of the item of heavy equipment;
(b) it is rectangular in cross-section through the respective longitudinal axis of the longitudinal member.

15. A kit as in claim 13 wherein the contoured member has at least one of the following features:
(a) the first and second regions form an angle of about 90 degrees to about 150 degrees;
(b) the contoured member further comprises a third region which is adjoined to and not coplanar with the second region.

16. A kit as in claim 15 wherein the first and second regions form an angle of about 90 degrees to about 130 degrees.

17. A kit as in claim 15 wherein the first and second regions form an angle of about 90 degrees or about 120 degrees.

18. A kit as in claim 13 wherein the apparatus further comprises a wedge attached to the longitudinal member and to the second region of the contoured member.

19. A kit as in claim 13 wherein the first attachment means comprises a screw or a bolt.

20. A kit as in claim 13 wherein the second attachment means comprises a screw or a bolt.
